(19) United States
(12) Patent Application Publication
(10) Pub. No.: US 2025/0223434 A1
(43) Pub. Date: Jul. 10, 2025

(54) BIODEGRADABLE THERMOPLASTIC BLEND COMPOSITIONS WITH MODIFIED STARCH-INDUCED FORCE RECOVERY PROPERTIES AND METHODS OF PRODUCTION THEREOF

(71) Applicant: Erthos Inc., Mississauga (CA)

(72) Inventors: Emmanuel Olusegun OGUNSONA, Mississauga (CA); Nima ZARRINBAKHSH, Mississauga (CA); Hossein ABDOLI, Mississauga (CA)

(21) Appl. No.: 18/404,492

(22) Filed: Jan. 4, 2024

(51) Int. Cl. C08L 67/00; B29B 7/00; B29C 48/68

(52) U.S. Cl. CPC C08L 67/00; B29B 7/002; B29C 48/681; C08G 2230/00; C08L 2201/12; C08L 2207/04

(57) ABSTRACT

The invention is a range of biodegradable thermoplastic compositions that exhibit force and form recovery. It encompasses thermoplastic polymer compositions which comprise at least one biodegradable thermoplastic polymer and at least one modified starch, and optionally other additives including but not limited to plasticizers, compatibilizers, fillers, coupling agents, and initiators. Different levels of force recovery can be achieved through resin preparation from different ingredient combinations and concentrations. The compositions exhibit physical and mechanical properties similar to those used for film and injection molding applications.

### FIELD OF INVENTION

The invention encompasses biodegradable thermoplastic polymer compositions for use in applications, such as extruded films, sheets, and profiles as well as injection molded rigid parts, within which a “force recovery” property is possessed as a targeted main advantage of the mechanical properties. Moreover, the invention encompasses the use of a specified weight percentage ranges of biodegradable thermoplastic polymers, modified starches, plasticizers, fillers, and other additives and combinations thereof, and protocols for the production of the biodegradable resins and evaluation of the force recovery of such products.

### BACKGROUND OF THE INVENTION

In the realm of conventional and petroleum-based polymeric materials, the force recovery behavior is present in elastomeric materials as observed from their strain recovery property. Such elastomeric materials include styrene block copolymers, thermoplastic polyolefin elastomers, thermoplastic copolyesters and thermoplastic polyurethanes, natural rubber and butadiene rubber just to mention a few. The strain recovery of these elastomers can accommodate high strains at high strain rates and return to their original shape and form with little to no loss in strength. The elasticity of polymeric materials is of great relevance in real-life applications.

Some examples of functional applications of polymers with great elasticity include:
1. Seals and gaskets: Polymers with good elasticity are often used to make seals and gaskets, as deformation can occur to fit around other components while also creating a resistance to the deformation as the material tends to return to its original shape and form, thereby creating a tight seal.
2. Sporting goods: The elasticity of a polymer can affect the performance of sporting goods, such as balls and gloves. For example, a golf ball with a high elasticity coefficient will compress upon impact and disperse that energy relatively quickly by returning to its original shape and form, resulting in higher launch momentum and therefore, longer distance traveled.
3. Packaging: Elastic polymers are often used in packaging to create stretch wraps or films, which can be stretched around a stack of items or containers; a resistance to stretching by the film creates a tight and secure seal and hold.
4. Medical devices: Medical devices and consumables such as gloves, catheters and stents are made from these types of polymers as they can conform to the shape of the body to provide support.

Overall, the elasticity of a polymer is an important factor to consider in a variety of applications, as it not only affects the performance and durability but also the functionality of the final product. However, most thermoplastic polymers or thermoplastic polymer blends with excellent elasticity do not typically exhibit rubber-like “recovery” or force recovery properties; they are significantly limited in recovering the original shape and property when strained and released. Likewise, the majority are synthesized from petroleum sources with few produced from bio-based and biodegradable materials.

Biodegradable polymers, or biopolymers, typically do not exhibit this rubber-like property, which restricts utilization in many applications that require some amount of elasticity. Hence, research into modifying biopolymers has garnered a lot of interest in improving ductility. However, no investigation has been reported on the recovery property.

The blending of two or more biopolymers has become a popular and effective method to improve mechanical performance. This provides an opportunity to harness the desired properties of the individual polymers. Most biopolymers have very poor ductility, which limits the application scopes. Hence, researchers have focused on ways to impart ductility, elasticity and flexibility to those biopolymers while maintaining biodegradability.

Blending biodegradable thermoplastic polyesters with other petroleum-based polymers can achieve these properties but are detrimental to biodegradation in most scenarios. Hence, these blends with petroleum-based polymers are not viable or an option for achieving a biodegradable composition with recovery. Therefore, biodegradable additives blended with biodegradable/compostable polymers provide a pathway to achieving biodegradable composition with recovery.

The ability of bio-based and/or biodegradable polymers to achieve “force recovery” after being stretched to a significant percentage of its original length has not been previously reported. Furthermore, there is no disclosure of the development of resins for the production of films and injection molded parts with this property.

### SUMMARY OF THE INVENTION

The invention encompasses biodegradable thermoplastic polymer compositions, which exhibit a range of force recovery properties with good mechanical properties required for various plastic applications.

In accordance with this invention, a combination of biopolymers and modified starch, and optionally other additives including, but not limited to, plasticizers, fillers, coupling agents, processing aids, compatibilizers, acidifiers, alkalizers and initiators are disclosed for use in melt blending processes in specific weight ratios to make compositions with commercially acceptable force recovery properties. The resin composition development can either be performed in one or multiple-stage processes, which encompasses different ingredient compositions and concentrations.

In certain embodiments, the resin development process extends the range of molecular weights of the different polymers that can be used and melt-blended at various weight ratios.

In one embodiment, the invention encompasses a biodegradable resin composition comprising in parts by mass (w/w) of about 10 to 99.99% of at least one biodegradable thermoplastic polymer including, but not limited to, a biodegradable thermoplastic polyester including but not limited to polylactic acid (PLA), polycaprolactone (PCL), polybutylene succinate (PBS), polybutylene succinate adipate (PBSA), polybutylene succinate terephthalate (PBST), polybutylene adipate-co-terephthalate (PBAT) and polyhydroxyalkanoates (PHAs). In various embodiments, the amount of the biodegradable thermoplastic polymer is about 10%, 12.5%, 15%, 17.5%, 20%, 22.5%, 25%, 27.5%, 30%, 32.5%, 35%, 37.5%, 40%, 42.5%, 45%, 47.5%, 50%, 52.5%, 55%, 57.5%, 60%, 62.5%, 65%, 67.5%, 70%, 72.5%, 75%, 77.5%, 80%, 82.5%, 85%, 87.5%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, 99.1%, 99.2%, 99.3%, 99.4%, 99.5%, 99.6%, 99.7%, 99.8%, 99.9%, or about 99.99%.

In certain embodiments, the biodegradable resin further comprises in parts by mass (w/w) of about 0.01 to 80% of at least one type of starch or modified starch. In various embodiments, the amount of the starch or modified starch is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, 40%, 42.5%, 45%, 47.5%, 50%, 52.5%, 55%, 57.5%, 60%, 62.5%, 65%, 67.5%, 70%, 72.5%, 75%, 77.5%, or about 80%.

The starch or modified starch includes, but is not limited to, cereal grains (e.g., corn, waxy corn, wheat, sorghum, rice, and waxy rice, which can also be used in the flour and cracked state), tubers of all types and nature such as potato, roots (tapioca for example cassava and manioc), sweet potato, and arrowroot, modified corn starch, and the pith of the sago palm. In various embodiments, these starches can be used either in their virgin or modified form (e.g., through epoxidation, carboxylation, hydroxylation, gelatinization, plasticization, and amidation). Among the raw materials for preparing the biodegradable resin, virgin and modified starches are also used as a substrate of the biodegradable plastics to increase the degradability, biobased content and most importantly, impart the recovery force property to the biopolymer resin. Optionally, the starch used as a filler and modified for use as a polymer is at least one selected from the group consisting of but not limited to corn starch, tapioca starch, rice starch, potato starch, wheat starch, rice starch weighed on a dry weight basis.

In one embodiment, the biodegradable resin further comprises in parts by mass (w/w) of 0 to about 40% of at least one plasticizer. In various embodiments, the amount of the plasticizer is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, or about 40%.

In various embodiments, the plasticizers encompass, but are not limited to, plant-based oils obtained from sources such as vegetables, nuts, grains, seeds, or combinations thereof. Examples of such oils include, but are not limited to, corn oil, soybean oil, and glycerol. These plant-based oils can be used either in their virgin form or modified form (e.g., through epoxidation, carboxylation, hydroxylation, and amidation). Modified plant-based oils such as epoxidized soybean oil, epoxidized linseed oil, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME) are also encompassed.

In one embodiment, the biodegradable resin further comprises in parts by mass (w/w) of about 0 to 10% of one or more coupling agents which encompasses both short and long-chain hydrocarbons with functional groups such as but not limited to epoxides, hydroxyls, anhydrides and citrates. In various embodiments, the amount of the one or more coupling agents is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or 10%.

In one embodiment, the biodegradable resin further comprises in parts by mass (w/w) of about 0 to 20% of fillers which encompasses both inorganic and biomass fillers and a combination thereof. In various embodiments, the amount of the fillers is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, or about 20%.

In certain embodiments, the inorganic fillers include, but are not limited to, wollastonite, mica, clay, calcium carbonate, glass fiber, talc, aluminum silicate, silicon dioxide, zirconium oxide, sepiolite, gypsum, and other minerals and a combination thereof.

In certain embodiments, the biomass filler material can include, but not limited to distillers' grains, vinasse, vinegar residues, wood fiber, agricultural cellulosic matter from including, but not limited to, straw, stalk, shive, hurd, bast, leaf, seed, fruit, and perennial grass, all in a non-continuous non-woven form including chopped pieces, particulates, dust or flour

In certain embodiments, the composition optionally further includes compatibilizers, chain extenders, peroxides, initiators, pigments, cross-linkers, or a combination thereof in a weight ratio ranging from 0 to 10 wt. %. In various embodiments, the amount of the compatibilizer, chain extenders, peroxides, initiators, pigments, cross-linkers, or a combination thereof is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, or about 10%.

In certain embodiments, the composition exhibits a bio-based carbon content of up to 100%. In certain embodiment, the composition exhibits a bio-based carbon content of about 10%, 20%, 30%, 40%, 50%, 60%, 70%, 80%, 90%, 95%, or about 100%.

In certain embodiments, the composition exhibits an MFI (melt flow index) of as low as 0.7 g/10 min and as high as 113 g/10 min at a temperature of 140° C.

In certain embodiments, the resin is a combination of any of the following polymers: polylactic acid, polycaprolactone, polybutylene succinate, polybutylene succinate adipate, polybutylene succinate terephthalate, polybutylene adipate-co-terephthalate, polyhydroxyalkanoates, starch or modified starch.

In one embodiment, the polymer is a mixture of starch or modified starch, polylactic acid and polybutylene adipate terephthalate.

In one embodiment, the polymer is a mixture of starch or modified starch, polylactic acid and polycaprolactone.

In one embodiment, the polymer is a mixture of starch or modified starch, polylactic acid and polybutylene succinate.

In one embodiment, the polymer is a mixture of starch or modified starch and polylactic acid.

In one embodiment, the polymer is a mixture of starch or modified starch and polybutylene succinate adipate.

In one embodiment, the polymer is a mixture of starch or modified starch, polylactic acid and polybutylene succinate adipate.

The embodiments include, but are not limited to the abovementioned combinations of biodegradable thermoplastic polyesters and starch and/or modified starch, but could encompass any other combinations of one or more of the thermoplastic polyesters and starch and/or modified starch.

In certain embodiments, the composition exhibits a force recovery, in machine direction of a cast extruded film, after an initial strain of 60% was applied at a rate of 500 mm/min and then reduced to a strain of 10% at a rate of 500 mm/min and held constant for 12 seconds.

In certain embodiments, the composition exhibits a force recovery of more than 10%, in machine direction of a cast extruded film, after an initial strain of 30% was applied at a rate of 500 mm/min and then reduced to a strain of 9% at a rate of 500 mm/min and held constant for 12 seconds.

In certain embodiments, the composition exhibits a force recovery of more than 8% in transverse direction of a cast extruded film, after an initial strain of 30% was applied at a rate of 500 mm/min and then reduced to a strain of 9% at a rate of 500 mm/min and held constant for 12 seconds.

In certain embodiments, the composition exhibits a force recovery of more than 6%, in machine direction of a cast extruded film, after an initial strain of 20% was applied at a rate of 500 mm/min and then reduced to a strain of 6% at a rate of 500 mm/min and held constant for 12 seconds.

In other embodiments, the invention encompasses a method for preparing the biodegradable composition comprising the following steps:
a. mixing of all the biodegradable thermoplastic polymers by means of a batch mixer or an extruder for a prescribed time period at temperatures higher than ambient temperatures to prepare a polymer melt,
b. addition of starch or modified starch(es) to the molten polymer blend,
c. mixing of additives such as plasticizers, compatibilizers, fillers, to the polymer melt for another prescribed period of time to make the final resin.

In other embodiments, the invention encompasses a method for preparing the biodegradable composition comprising the following steps:
a. mixing of all the biodegradable thermoplastic polymers and additives such as plasticizers, compatibilizers, fillers, together by means of a batch mixer or an extruder for a prescribed time period at temperatures higher than ambient temperatures, and
b. mixing the starch or modified starch to make the final resin.

In other embodiments, the invention encompasses a method for preparing the biodegradable composition comprising the following steps:
a. mixing of all starch or modified starch with additives such as plasticizers, compatibilizers, fillers, or combinations thereof
b. adding biodegradable thermoplastic polymers to the additive/starch mixture by means of a batch mixer or an extruder for a prescribed time period at temperatures higher than ambient temperatures to make the final resin.

The order of adding ingredients is not limited to the aforementioned methods and could include numerous orders and combinations.

In certain embodiments, the method further comprises forming articles in any shape and rigidity using conventional polymer processing techniques such as thermoforming, hot press, vacuum forming, cast extrusion, film blowing, injection molding or compression molding.

In one embodiment, the process of producing the resin formulation includes extrusion, where the extrudate is formed at a temperature above ambient temperature, preferably in a range of about 50 to about 250° C.

In certain embodiments, the invention encompasses a disposable product, comprising the biodegradable composition, wherein the disposable product is packing material or a consumer product.

In certain embodiments, the biodegradable compositions of the invention can be used in various embodiments from single-use products to durable products and in a wide range of applications, from packaging to medical, consumer products and many more.

In various embodiments, the invention encompasses a biodegradable resin composition comprising:
about 10 to about 99.99% (w/w) of one or more biodegradable thermoplastic polymers;
about 0.01 to about 80% (w/w) of one or more biodegradable modified starch;
about 0 to about 40% (w/w) of one or more plasticizers;
about 0 to about 20% (w/w) of one or more of inorganic fillers;
about 0 to about 20% (w/w) of one or more of biomass fillers;
about 0 to about 10% (w/w) of one or more of additives such as coupling agents, compatibilizing agents, processing aids, chain extenders, initiators, peroxides, impact modifiers and pigments.

In certain embodiments, the composition exhibits force recovery property shortly after being stretched to a certain strain and then returned to a lower strain and held for a period of time.

In certain embodiments, the resin composition exhibits at least about 5% force recovery within about 60 seconds, while being held at a holding strain of at least 5% after returning from an initial strain of at least about 10% that falls beyond the elastic region on the tensile stress-strain curve of the resin composition. The strain rate to stretch to the initial strain and to return to the holding strain is about 0.1 to about 1500 mm/min, and the percentage of the recovered force is measured with respect to the maximum force causing the initial strain.

In certain embodiments, the biodegradable thermoplastic polymer is one or more of biodegradable thermoplastic polyesters selected from the group consisting of polylactic acid, polycaprolactone, polybutylene succinate, polybutylene succinate adipate, polybutylene succinate terephthalate, polybutylene adipate-co-terephthalate, polyhydroxyalkanoates and combinations thereof.

In certain embodiments, the biodegradable modified starch is selected from the group consisting of oxidized starch, esterified starch, plasticized starch, thermoplastic starch, hydrophilicized starch, hydrophobicized starch and enzyme-treated starch, or combinations thereof.

In certain embodiments, the plasticizer is one or more plant-based oils obtained from vegetables, nuts, grains, seeds.

In certain embodiments, the oil is selected from the group consisting of corn oil, soybean oil, and glycerol. In certain embodiments, the plant-based oils can be used either in their virgin form or after modification (e.g., through epoxidation, carboxylation, hydroxylation, and amidation). Modified plant-based oils such as epoxidized soybean oil, epoxidized linseed oil, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME), are also encompassed.

In certain embodiments, the inorganic filler is selected from the group consisting of wollastonite, mica, clay, calcium carbonate, glass fiber, talc, aluminum silicate, zirconium oxide, sepiolite, gypsum or combinations thereof.

In certain embodiments, the biomass is selected from the group consisting of distillers' grains, vinasse, vinegar residues, wood fiber, virgin starch, agricultural cellulosic matter from including but not limited to straw, stalk, shive, hurd, bast, leaf, seed, fruit, and perennial grass, all in a non-continuous non-woven form, which may consist of chopped pieces, particulates, dust, or flour or a combination thereof.

In certain embodiments, the composition exhibits 10%, 20%, 30%, 40%, 50%. 60%, 70%, 80%, or 90% disintegration completion within about 180 to about 365 days at ambient temperature.

In certain embodiments, the composition exhibits 10%, 20%, 30%, 40%, 50%. 60%, 70%, 80%, or 90% disintegration completion within about 180 to about 365 days in soil at ambient temperature.

In certain embodiments, the composition exhibits more than 90% disintegration in less than 30, 35, 40, 45, 50, 55, 60, 65, 70, 75, 80, 81, 82, 83, 84, 85, 86, 87, 88, 89, or 90 days.

In certain embodiments, the composition exhibits more than 90% biodegradation in less than 30, 35, 40, 45, 50, 55, 60, 65, 70, 75, 80, 85, 90, 100, 110, 120, 130, 140, 150, 160, 170, 175, or 180 days under thermophilic temperature conditions.

In another embodiment, the invention encompasses a method of producing the biodegradable resin composition in which ingredients are mixed and melt-compounded together in a polymer processing equipment or apparatus selected from the group consisting of batch mixer, a twin screw extruder or a single screw extruder, at elevated temperatures for a time period of several seconds to several minutes.

In certain embodiments, the bio-based carbon content of the composition is up to 100%.

In certain embodiments, the biodegradable resin composition is for use in articles of any thickness and rigidity made using polymer processing techniques selected from blown and cast film extrusion, compression molding, and injection molding techniques.

### DETAILED DESCRIPTION OF THE INVENTION

To facilitate an understanding of the invention, it will be described more comprehensively herein below. However, the invention may be embodied in different forms and is not limited to the embodiments set forth herein. Rather, these embodiments are provided for the purpose of making the disclosure of the invention more thorough and comprehensive.

Unless otherwise defined, all technical and scientific terms used herein have the same meaning as those commonly understood by a person skilled in the art to which the present invention belongs. Terms used in the specification of the present invention are only for the purpose of describing specific embodiments, and are not intended to limit the present invention.

### Definitions

The term “modified starch” is herein defined as starch is transformed from its native form by typical processes known in the art including, physical, physiochemical, biological, biochemical or chemical processes such as, for example, plasticization, gelatinization, esterification, etherification, oxidation, acid hydrolysis, cross-linking, and enzyme conversion. Typical starch or modified starches include esters, such as the acetate and, the half-esters of dicarboxylic acids/anhydrides, particularly the alkenyl succinic acids/anhydrides; ethers, such as the hydroxyethyl and hydroxypropyl starches; oxidized starches, such as those oxidized with hypochlorite; starches reacted with cross-linking agents, such as phosphorus oxychloride, epichlorohydrin, hydrophobic cationic epoxides, and phosphate derivatives prepared by reaction with sodium or potassium orthophosphate or tripolyphosphate, and combinations thereof. Preferred starches can include any starch or modified starch that is initially in a native state as a granular solid, and obtained from sources such as, but not limited to cereal grains (e.g. corn, waxy corn, wheat, sorghum, rice, and waxy rice, which can also be used in the flour and cracked state), tubers of all types and nature such as potato, roots (tapioca (i.e., cassava and manioc), sweet potato, and arrowroot, modified corn starch, and the pith of the sago palm. Other ingredients of the modified starch could contain at least one polyol including but not limited to sorbitol, mannitol, galactitol, xylitol, ribitol, arabitol, erythritol, glycerol, threitol and a derivative thereof, and at least one organic acid such as saturated or unsaturated dicarboxylic acid including but not limited to succinic acid, sebacic acid, glutaric acid, hexanedioic acid, heptanoic acid, octanedioic acid, nonanedioic acid, and decanoic acid or a derivative thereof, and additives such as but not limited to water, crosslinkers, initiators, alkalizers, acidifiers, peroxides, coupling agents, fillers, compatibilizing agents, pigments and combinations thereof.

The term “thermoplastic starch (TPS)” is herein defined to refer to thermoplastic polymers produced from one or more starch that has been gelatinized or plasticized in the presence of heat above ambient temperature and shear, using ingredients such as but not limited to one or more polyols, organic acids and additives such as but not limited to water, crosslinkers, initiators, alkalizers, acidifiers, peroxides, coupling agents, fillers, compatibilizing agents, pigments and combinations thereof.

The term “biobased” or “bio-based” refers to compositions that are derived from plant matter instead of being made from petroleum or natural gas. Because they are plant-based, there is a tendency to assume that the type of plastic must be biodegradable. However, this is not the case for all plant-based compositions. The bio-based compositions of the invention can be designed to biodegrade in less than 6 months.

The term “thermoplastic”, as used herein, refers to a polymer, which softens when heated and becomes moldable and pliable then hardens when cooled.

The prefix “bio” as used herein refers to a material that has been derived from a renewable biological resource.

The terms “blend” and “resin” as used herein interchangeably, refer to a homogeneous mixture of two or more different polymers and plasticizers along with other ingredients.

The term “machine direction” or “MD” refers to the direction parallel to the pull of an extruded polymer film from the die during a cast extrusion process.

The term “transverse direction” or “TD” refers to the direction perpendicular to the pull of an extruded polymer film from the die during a cast extrusion process.

The term “biodegradable” refers to compositions of the invention that can biodegrade within 12 months in a compost environment in a non-toxic, environmentally compatible manner with no heavy metal nor PTFE content, and remaining soil-safe (i.e., lack of eco-toxins). The compositions of the invention biodegrade within 12 months. Compostable plastic is biodegradable, but not every plastic that is biodegradable is compostable. The compositions of the invention are both biodegradable and compostable. As used herein, “biodegradable” compositions are engineered to biodegrade in compost, soil, or water. In particular, biodegradable plastics are plastics with innovative molecular structures that can be decomposed by bacteria at the end of their life under certain environmental conditions.

The term “bioplastics” or “biopolymer” is used to refer to plastics that are bio-based, biodegradable, or fit both criteria. Bio-based plastics of the invention are fully or partly made from renewable feedstock derived from biomass. Commonly used raw materials to produce these renewable feedstock for plastic production include, but are not limited to, corn starch, corn stalks, sugarcane stems, cellulose, and various oils and fats from renewable sources.

The term “compostable” compositions refer to biodegradation into soil conditioning material (i.e., compost). In order for a plastic to be labeled as commercially “compostable” it should be broken down by biological treatment at an industrial composting facility in 180 days or less. Composting utilizes microorganisms, agitation, heat, and humidity to yield carbon dioxide, water, inorganic compounds, and biomass that is similar in characteristic to the rest of the finished compost product. Decomposition of the composition should occur at a rate similar to the other elements of the material being composted (e.g., within 6 months) and leave no toxic residue that would adversely impact the ability of the finished compost to support plant growth. ASTM Standards D6400 and D6868 outline the specifications that must be met in order to label a plastic as “industrial compostable”.

The term “disintegration” refers to a plastic product that leaves no more than 10% of its original dry weight after twelve weeks (84 days) in a controlled thermophilic composting test and sieved through a 2.0 mm mesh.

As used herein, “recovery” or “force recovery” also refers to the property of the material (resin composition developed herein), refers to the ability of the material to recover a percentage of its strength within its plastic region, within a specified time frame. The force recovery can be measured using testing equipment such as a universal testing machine (UTM) via the following procedure: the material is first stretched to an “initial strain” beyond the elastic region on its tensile stress-strain curve, at a specific strain rate. At this strain, the “maximum force” is recorded. Following this, the sample is returned from its initial strain to a “holding strain”, at a specific strain rate, and held at this holding strain for a specific period of time referred to as the “holding time”. The final step involves measuring the percentage of the force recovered relative to the maximum force recorded, which is then reported as the force recovery of the composition.

The term “polyesters” refers to polymers of the invention that are obtained, for example, by aliphatic diols, aliphatic dicarboxylic acids, and aromatic dicarboxylic acids/esters. The term polyesters also includes aliphatic-aromatic polyesters. The biodegradable thermoplastic polyesters of the current invention include but are not limited to: polylactic acid (PLA) or poly(lactic acid) (PLA); polycaprolactone (PCL); poly(butylene succinate) (PBS) or polybutylene succinate (PBS); poly(butylene succinate adipate) (PBSA), polybutylene succinate adipate (PBSA), poly(butylene succinate-co-adipate) (PBSA), polybutylene succinate-co-adipate (PBSA); poly(butylene succinate-co-butylene adipate) (PBSA) or polybutylene succinate-co-butylene adipate (PBSA); poly(butylene succinate terephthalate) (PBST), polybutylene succinate terephthalate (PBST), poly(butylene succinate-co-terephthalate) (PBST), polybutylene succinate-co-terephthalate (PBST), poly(butylene succinate-co-butylene terephthalate) (PBST) or polybutylene succinate-co-butylene terephthalate (PBST); poly(butylene adipate terephthalate) (PBAT), polybutylene adipate terephthalate (PBAT), poly(butylene adipate-co-terephthalate) (PBAT), polybutylene adipate-co-terephthalate (PBAT), poly(butylene adipate-co-butylene terephthalate) (PBAT) or polybutylene adipate-co-butylene terephthalate (PBAT); and polyhydroxyalkanoates (PHAs).

As used herein, “additive” could refer to material used to enhance a targeted property or function of material and/or composition, which could be in any form such as solid, liquid, powder, fiber, or crystal.

The term polyhydroxyalkanoates (PHAs) refers to a family of bio-based thermoplastic polyesters synthesized by various microorganisms, particularly through bacterial fermentation. The PHA family encompasses over 150 different monomers, allowing for the production of materials with a wide range of properties. Notably, these plastics are biodegradable and include, but are not limited to, poly-3-hydroxybutyrate (PHB), polyhydroxybutyrate-co-hydroxyvalerate (PHBV), poly-4-hydroxybutyrate (P4HB), polyhydroxybutyrate-co-hydroxyhexanoate (PHBH), polyhydroxyvalerate (PHV), polyhydroxyhexanoate (PHH), polyhydroxyoctanoate (PHO), polyhydroxydecanoate (PHD), and polyhydroxydodecanoate (PHDD).

As used herein, “wt. %”, “parts by mass (w/w)” or “parts by mass % (w/w)” refer to the percentage weight of an ingredient with respect to the total weight of a composition.

### Compositions of the Invention

The invention generally encompasses the development of biodegradable thermoplastic resin compositions that exhibit force recovery properties. In general, the biodegradable compositions of the invention can be considered valid alternative materials to those produced from petroleum resources.

The biodegradable thermoplastic polymers of the biodegradable resin composition can be derived from natural resources. In certain embodiments, the biodegradable thermoplastic polymers of the invention include biodegradable thermoplastic polyesters or modified starch.

In certain embodiments, the biodegradable thermoplastic polymer includes biodegradable thermoplastic polyesters including, but not limited to, one or more of polylactic acid, polycaprolactone, polybutylene succinate, polybutylene succinate adipate, polybutylene succinate terephthalate, polybutylene adipate terephthalate, polyhydroxyalkanoates or combinations thereof.

In certain embodiment, the compositions may include, but are not limited to, any of the following polymer combinations:

In certain embodiments, the biodegradable thermoplastic polyesters include polylactic acid and polycaprolactone.

In certain embodiments, the biodegradable thermoplastic polyesters include polylactic acid and polybutylene succinate.

In certain embodiments, the biodegradable thermoplastic polyesters include polylactic acid and polybutylene succinate adipate.

In certain embodiments, the biodegradable thermoplastic polyesters include polylactic acid and polybutylene succinate terephthalate.

In certain embodiments, the biodegradable thermoplastic polyesters include polylactic acid and polybutylene adipate terephthalate.

In certain embodiments, the biodegradable thermoplastic polyesters include polylactic acid and polyhydroxyalkanoates.

In certain embodiments, the biodegradable thermoplastic polyesters include polycaprolactone and polybutylene succinate.

In certain embodiments, the biodegradable thermoplastic polyesters include polycaprolactone and polybutylene succinate adipate.

In certain embodiments, the biodegradable thermoplastic polyesters include polycaprolactone and polybutylene succinate terephthalate.

In certain embodiments, the biodegradable thermoplastic polyesters include polycaprolactone and polybutylene adipate terephthalate.

In certain embodiments, the biodegradable thermoplastic polyesters include polycaprolactone and polyhydroxyalkanoates.

In certain embodiments, the biodegradable thermoplastic polyesters include polybutylene succinate and polybutylene succinate adipate.

In certain embodiments, the biodegradable thermoplastic polyesters include polybutylene succinate and polybutylene succinate terephthalate.

In certain embodiments, the biodegradable thermoplastic polyesters include polybutylene succinate and polybutylene adipate terephthalate.

In certain embodiments, the biodegradable thermoplastic polyesters include polybutylene succinate and polyhydroxyalkanoates.

In certain embodiments, the biodegradable thermoplastic polyesters include polybutylene succinate adipate and polybutylene succinate terephthalate.

In certain embodiments, the biodegradable thermoplastic polyesters include polybutylene succinate adipate and polybutylene adipate terephthalate.

In certain embodiments, the biodegradable thermoplastic polyesters include polybutylene succinate adipate and polyhydroxyalkanoates.

In certain embodiments, the biodegradable thermoplastic polyesters include polybutylene succinate terephthalate and polybutylene adipate terephthalate.

In certain embodiments, the biodegradable thermoplastic polyesters include polybutylene succinate terephthalate and polyhydroxyalkanoates.

The abovementioned embodiments are not limited to binary combinations of biodegradable thermoplastic polyesters, but could encompass combinations of three or more biodegradable thermoplastic polyesters.

In various embodiments, the biodegradable compositions of the invention include a modified starch. In certain embodiments, the compositions further include modified starch which is a product of at least one starch or its derivatives, including any known starch material. Preferred starches can include any starch or modified starch that is initially in a native state as a granular solid and which will form a thermoplastic melt by mixing and heating.

In certain embodiments, starch includes a natural carbohydrate chain comprising polymerized glucose molecules in an alpha-(1,4) linkage and is found in nature in the form of granules. Starches used in compositions of certain embodiments of the invention include the following properties: the ability to maintain structure in the presence of many types of other materials, and the ability to be thermally stable and melt into plastic-like materials at a range of temperatures, for example, between about 50 to about 220° C., preferably between about 50 and about 200° C., and in the presence of a wide range of materials and in moist environments and to exhibit high binding strengths.

In certain embodiments, sources of starch may include, for example, cereal grains (e.g. corn, waxy corn, wheat, sorghum, rice, and waxy rice, which can also be used in the flour and cracked state), tubers of all types and nature such as potato, roots (tapioca (i.e., cassava and manioc), sweet potato, and arrowroot, modified corn starch, and the pith of the sago palm.

In general, starch granules are insoluble in cold water. It is possible to reduce the amount of water in starch melts by replacing the water inherently found in starch with an appropriate low volatile plasticizer capable of causing starch to melt below its decomposition temperature, such as polyalkylene oxides, glycerin, mono- and diacetates of glycerin, sorbitol, other sugar alcohols, and citrates. This can allow for improved processability, greater mechanical strength, better dimensional stability over time, and greater ease in blending the starch melt with other polymers.

Suitable starches can also be selected from, but not limited to, the following: ahipa, apio (arracacha), arrowhead (arrowroot, Chinese potato, jicama), baddo, bitter cassava, Brazilian arrowroot, cassava (yucca), Chinese artichoke (crosne), Japanese artichoke (chorogi), Chinese water chestnut, coco, cocoyam, dasheen, eddo, elephant's ear, girasole, goo, Japanese potato, Jerusalem artichoke (sunroot, girasole), lily root, ling gaw, malanga (tanier), plantain, sweet potato, mandioca, manioc, Mexican potato, Mexican yarn bean, old cocoyam, saa got, sato-imo, seegoo, sunchoke, sunroot, sweet cassava, tanier, tannia, tannier, tapioca root, taro, topinambour, water chestnut, water lily root, yam bean, yam, yautia, barley, corn, sorghum, rice, wheat, oats, buckwheat, rye, kamut brand wheat, triticale, spelt, amaranth, black quinoa, hie, millet, plantago seed husks, psyllium seed husks, quinoa flakes, quinoa, teff.

Starches that can be used in the compositions of the invention include starch or modified starches. The term “modified starch” refers to starch that is transformed from its native form by typical processes known in the art including, physical, physiochemical, biological, biochemical or chemical processes such as, for example, plasticization, gelatinization, esterification, etherification, oxidation, acid hydrolysis, cross-linking, and enzyme conversion. Typical starch or modified starches include esters, such as the acetate and, the half-esters of dicarboxylic acids/anhydrides, particularly the alkenyl succinic acids/anhydrides; ethers, such as the hydroxyethyl and hydroxypropyl starches; oxidized starches, such as those oxidized with hypochlorite; starches reacted with cross-linking agents, such as phosphorus oxychloride, epichlorohydrin, hydrophobic cationic epoxides, and phosphate derivatives prepared by reaction with sodium or potassium orthophosphate or tripolyphosphate, and combinations thereof. The invention also encompasses starch or modified starch prepared by physically, enzymatically, or chemically treating native starch to change its properties. Starch or modified starches are used in practically all starch applications, such as in food products as a thickening agent, stabilizer or emulsifier; in pharmaceuticals as a disintegrant; or as binder in coated paper. They are also used in many other applications. Starches are modified to enhance their performance in different applications. Starches may be modified to increase their stability against excessive heat, acid, shear, time, cooling, or freezing; to change their texture; to decrease or increase their viscosity; to lengthen or shorten gelatinization time; or to increase their visco-stability. Starch or modified starches also include long-chain alkyl starches, dextrins, amine starches, and dialdehyde starches. In other embodiments, the starches also include compositions based on plasticized starch, the so-called “thermoplastic starch.” These multiphase materials are obtained when combining plasticized starches and other biodegradable materials, such as biodegradable polyesters (polycaprolactone (PCL), polyhydroxyalkanoates (PHAs), polylactic acid (PLA), polyesteramide (PEA), aliphatic, and aromatic copolyesters, or agro-materials (ligno-cellulosic fiber, lignin etc.). Depending on materials (soft, rigid) and the plastic processing system used, various structures (blends, composites, multi layers) can be obtained.

The production of modified starch encompasses but is not limited to the use of processing equipment such as fermentation and thermal reactors, batch mixers, single and twin screw extruders and kettle-style mixers. In various scenarios where the modified starch is produced using different methods, the ingredients vary accordingly. The modified starch can be produced in multi-step processes.

In one embodiment, the starch can be pre-modified by means of any of the aforementioned processes and then mixed with other additives in a polymer compounding equipment.

In another embodiment, the starch is mixed directly with other additives in a polymer compounding equipment without premodification.

In another embodiment, the starch is mixed with some of the required additives and then later mixed further downstream with the rest of the required additives in a polymer compounding equipment.

In another embodiment, a pre-modified starch by means of any of the typical processes is mixed with some of the required additives and then later mixed further downstream with the rest of the required additives in a polymer compounding equipment.

In certain embodiments, water is used to premodify the starch prior to addition of other additives to produce the modified starch.

In certain embodiments, water and other additives are added all at once to the starch to produce the modified starch.

In certain embodiments, water is premixed with the additives, processed using any of the polymer processing equipment such as extruders or batch mixers at elevated temperatures for various time periods prior to the addition of starch.

In certain embodiments, the modified starch is produced using any of the polymer processing techniques from an aged premix of starch and additives.

In other embodiments, the modified starch is produced using any of the polymer processing techniques from a freshly prepared premix of starch and additives.

In other embodiments, the modified starch is produced using any of the polymer processing techniques from a freshly prepared premix of starch and some additives with the addition of the rest of the additives later downstream of the process.

In certain embodiments, the plasticizers of the biodegradable resin composition of the invention include, but are not limited to, at least one or more plant-based oils obtained from sources such as vegetables, nuts, grains, seeds, etc. Examples of such oils include, but are not limited to, corn oil, soybean oil, and glycerol. These plant-based oils can be used either in their virgin form or after modification (e.g., through epoxidation, carboxylation, hydroxylation, and amidation). Modified plant-based oils such as epoxidized soybean oil, epoxidized linseed oil, and a range of citrate plasticizers (e.g., acetyl tributyl citrate (ATBC), triethyl citrate (TEC), acetyl triethyl citrate (ATEC), tributyl citrate (TBC)), as well as isosorbide-type plasticizers, natural waxes, glycol, sugar alcohols (e.g. xylitol, sorbitol, lactitol, mannitol, erythritol, maltitol), isosorbide diester, and fatty acid methyl esters (FAME) are also encompassed.

In certain embodiments, the biodegradable resin compositions can optionally further include inorganic fillers not limited to, wollastonite, mica, clay, calcium carbonate, glass fiber, talc, aluminum silicate, zirconium oxide, sepiolite, and gypsum.

In certain embodiments, the biodegradable resin compositions can optionally further include biomass fillers and organic fillers including but not limited to, distillers' grains, vinasse, vinegar residues, wood fiber, native starch, grains, agricultural cellulosic matter from including but not limited to straw, stalk, shive, hurd, bast, leaf, seed, fruit, and perennial grass, all in a non-continuous non-woven form including chopped pieces, particulates, dust or flour. The starch used as a filler is at least one selected from the group consisting of but not limited to corn starch, potato starch, wheat starch and rice starch, measured on a dry weight basis.

In certain embodiments, the biodegradable resin composition can optionally further include additives such as but not limited to crosslinkers, processing aids, initiators, peroxides, coupling agents, fillers, compatibilizing agents, pigments and chain extenders.

In certain embodiments, the biodegradable resin composition comprises about 10 to about 99.99% (w/w) of one or more biodegradable thermoplastic polymers; about 0.01 to about 80% (w/w) of one or more biodegradable modified starch; about 0 to about 40% (w/w) of one or more plasticizers; about 0 to about 20% (w/w) of one or more of inorganic fillers; about 0 to about 20% (w/w) of one or more of biomass fillers; about 0 to about 10% (w/w) of one or more of additives such as coupling agents, processing aids, compatibilizing agents, chain extenders, initiators, peroxides, impact modifiers and pigments.

### Biodegradable Resin Composition Production

The components of the biodegradable resin compositions may be processed together in various embodiments. In certain embodiments, all ingredients are premixed and melt-processed together.

In certain embodiments, the biodegradable thermoplastic polymer(s) will be plasticized and then melt-processed with the biodegradable modified starch(es) and other additives. In certain embodiments, one or more of the biodegradable thermoplastic polymer(s) will be melt-processed, followed by the addition of the biodegradable modified starch(es), and subsequently, the other biopolymer(s) and additives. Alternatively, the biodegradable thermoplastic polymer(s) may be initially partially plasticized with a portion of the plasticizer(s) used followed by the addition of the biodegradable modified starch(es), and other additives along with the rest of the plasticizer(s). Furthermore, the additives may be added to the biodegradable thermoplastic polymer(s) before the addition of the biodegradable modified starch(es). In yet another scenario, only one of the biodegradable biopolymers is initially melt-processed with the biodegradable modified starch(es) and a portion of the additives, before subsequently melt-processing with the rest of the additives and other biodegradable biopolymers. The blending or processing of the ingredients are not limited to the aforementioned scenarios but may include all possible ingredient combination embodiments.

The blending of the components may be achieved using mixing and melt-compounding equipment with adjustable and controllable temperatures and mixing speed, such as a single or twin screw extruder or a batch kneader. In a batch kneader, the processing temperature profile may range from about 50 to about 250° C., and the processing time may be between about 1 to about 60 minutes. Alternatively, in scenarios where single or twin screw extrusion is employed, the temperature profile may range from about 50 to about 250° C., and the screw speed may range from about 50 to about 500 rpm. It should be noted that the processing conditions provided herein are not limiting and may vary based on other conditions such as ingredient ratios and processing equipment. The resulting product may be formed into films, sheets or more rigid parts using conventional cast extrusion, blown film extrusion, injection molding or compression molding techniques. Alternatively, the resulting product may be pelletized or crushed into powder and then injection molded or compression molded into plastic parts of higher thicknesses. The extrusion, injection or compression temperature is typically within the range used in the melt-processing and compounding of the resins and ingredients.

### Force Recovery Measurement Test Method

The force recovery can be measured using a universal testing machine (UTM) via different methods including but not limited to the following:

Testing can be conducted using a sample size specified by ASTM D882, measuring 2 cm in width and 15 cm in length. This includes a 10 cm testing area and 2.5 cm on each side reserved for gripping.
a. (i) The sample is stretched to an initial strain of at least 10% that falls beyond the elastic region on the tensile stress-strain curve, with a strain rate between 0.1 to 1500 mm/min.
b. (ii) The “maximum force” that causes this strain is recorded.
c. (iii) The sample is returned from the initial strain to a minimum strain of 5% with a strain rate of 0.1 to 1500 mm/min and is held under this “holding strain” for a certain amount of time, typically from about a few seconds to about 60 seconds, during which the force being recovered is measured.
d. (iv) The percentage of the force recovered at any given time under the holding strain is then calculated with respect to the recorded maximum force from step (ii) and is reported as the force recovery of the composition at that time under the holding strain.

In one embodiment, the force recovery is evaluated by stretching the sample at a strain rate of 50 mm/min until it reaches a strain of 20%. Once this strain is achieved, the grips retract at a rate of 500 mm/min until a strain of 6% is attained. The sample's force recovery is then monitored for 12 seconds. The maximum percentage of force recovery reached within 12 seconds with respect to the maximum force reached during the initial stretch, is then calculated.

In one embodiment, the force recovery is evaluated by stretching the sample at a strain rate of 50 mm/min until it reaches a strain of 30%. Once this strain is achieved, the grips retract at a rate of 500 mm/min until a strain of 9% is attained. The sample's force recovery is then monitored for 12 seconds. The maximum percentage of force recovery reached within 12 seconds, with respect to the maximum force reached during the initial stretch, is then calculated.

In one embodiment, the force recovery is evaluated by stretching the sample at a strain rate of 500 mm/min until it reaches a strain of 40%. Once this strain is achieved, the grips retract at a rate of 500 mm/min until a strain of 12% is attained. The sample's force recovery is then monitored for 12 seconds. The maximum percentage of force recovery reached within 12 seconds, with respect to the maximum force reached during the initial stretch, is then calculated.

In one embodiment, the force recovery is evaluated by stretching the sample at a strain rate of 500 mm/min until it reaches a strain of 50%. Once this strain is achieved, the grips retract at a rate of 500 mm/min until a strain of 15% is attained. The sample's force recovery is then monitored for 12 seconds. The maximum percentage of force recovery reached within 12 seconds, with respect to the maximum force reached during the initial stretch, is then calculated.

In one embodiment, the force recovery is evaluated by stretching the sample at a strain rate of 50 mm/min until it reaches a strain of 20%. Once this strain is achieved, the grips retract at a rate of 50 mm/min until a strain of 10% is attained. The sample's force recovery is then monitored for 60 seconds. The maximum percentage of force recovery reached within 60 seconds, with respect to the maximum force reached during the initial stretch, is then calculated.

In one embodiment, the force recovery is evaluated by stretching the sample at a strain rate of 10 mm/min until it reaches a strain of 50%. Once this strain is achieved, the grips retract at a rate of 200 mm/min until a strain of 15% is attained. The sample's force recovery is then monitored for 60 seconds. The maximum percentage of force recovery reached within 60 seconds, with respect to the maximum force reached during the initial stretch, is then calculated.

The force recovery test is not limited to the aforementioned procedures and could include any other initial strains, holding times, holding strains, strain rates and sample size.

### General Embodiments of the Invention

The invention generally encompasses compositions and methods of manufacturing a biodegradable composition including, but not limited to, about 10 to about 99.99% (w/w) of one or more biodegradable thermoplastic polymers; about 0.01 to about 80% (w/w) of one or more modified starches; about 0 to about 40% (w/w) of one or more of plasticizers; about 0 to about 20% (w/w) of one or more of inorganic fillers; about 0 to about 20% (w/w) of one or more of organic fillers or biomass; about 0 to about 10% (w/w) of one or more of additives such as coupling agents, processing aids, compatibilizing agents, chain extenders, initiators, peroxides, impact modifiers and pigments.

The methods of manufacturing of the aforementioned composition combinations may be achieved using mixing and melt-compounding equipment with adjustable and controllable temperatures and mixing speeds, such as a single or twin screw extruder or a batch kneader. In a batch kneader, the processing temperature profile may range from about 50 to about 250° C., and the processing time may be between about 1 to about 60 minutes. Alternatively, in scenarios where single or twin screw extrusion is employed, the temperature profile may range from about 50 to about 250° C., and the screw speed may range from about 50 to about 500 rpm. It should be noted that the processing conditions provided herein are not limiting and may vary based on other conditions such as ingredient ratios and processing equipment. The resulting product may be formed into films, sheets or more rigid parts using conventional cast extrusion, blown film extrusion, injection molding or compression molding techniques. Alternatively, the resulting product may be pelletized or crushed into powder and then injection molded or compression molded into plastic parts of higher thicknesses. The extrusion or compression temperature is typically within the range used in the melt-processing and compounding of the resins and ingredients.

In certain embodiments, the compositions exhibit a bio-based carbon content of up to 100%.

In certain embodiments, the composition exhibits a force recovery of more than 10%, in machine direction, after an initial strain of 30% was applied at a rate of 500 mm/min and then reduced to a holding strain of 9% at a rate of 500 mm/min and held constant for 12 seconds.

In certain embodiments, the composition exhibits a force recovery of more than 8% in transverse direction, after an initial strain of 30% was applied at a rate of 500 mm/min and then reduced to a holding strain of 9% at a rate of 500 mm/min and held constant for 12 seconds.

In certain embodiments, the composition exhibits a force recovery of more than 6%, in machine direction, after an initial strain of 20% was applied at a rate of 500 mm/min and then reduced to a holding strain of 6% at a rate of 500 mm/min and held constant for 12 seconds.

### EXAMPLES

Example 1: A kneader was pre-heated to 230° C. before the addition of PBAT. It was allowed to melt before TPS was added. A weight ratio of 45/55 (PBAT/TPS) was employed for this resin composition. The temperature of the kneader was reduced to 165° C. and the polymers were allowed to mix for 10 minutes under a mixing speed of 35 rpm until a uniform melt was formed. The resulting material was extracted from the kneader, cooled to room temperature and crushed into powder using a mechanical crusher.

The crushed material was compression molded into film with an average thickness of 0.69 mm and a width of 10-12 inches, using a compression molding machine at a pressure of 130 kg/cm² for 2 mins. The sheet was cut into test strips for analysis of its mechanical properties. The mechanical properties and MFI of the produced resin and the extruded film were tested using a UTM and a melt flow indexer according to ASTM methods, as well as the force recovery test method defined previously. The results are shown in Table 1.

Example 2: A kneader was pre-heated to 230° C. before the addition of PBAT. It was allowed to melt before TPS was added. The temperature of the kneader was reduced to 165° C. and allowed to mix further for 10 minutes under a mixing speed of 35 rpm until a uniform melt was formed. The resulting material was extracted from the kneader, cooled to room temperature and crushed using a mechanical crusher. The crushed material was then premixed with PLA and ATBC in a mixing container then fed into an extruder with a temperature profile across 9 zones ranging from 140 to 170° C. and at a screw speed of 100 rpm. A weight ratio of 10/50/25/15 (ATBC/TPS/PBAT/PLA) was employed for this resin composition. The extrudate was collected, pelletized and extruded into film with an average thickness of 0.26 mm and a width of 10-12 inches, using a cast film extruder with a temperature profile of 160 to 170° C. and a screw speed of 50 rpm. The film was chilled and pulled via a set of chiller, guiding and winding rollers to be collected with a spool. The mechanical properties and MFI of the produced resin and the extruded film were then evaluated using a UTM and a melt flow indexer according to ASTM methods, as well as the force recovery test method defined previously. The results are shown in Table 1.

Example 3: A kneader was pre-heated to 230° C. before the addition of PLA. It was allowed to melt before TPS was added. The temperature of the kneader was reduced to 185° C. and allowed to mix further for 10 minutes under a mixing speed of 35 rpm until a uniform melt was formed. The resulting material was extracted from the kneader, cooled to room temperature and crushed using a mechanical crusher. The crushed material was then premixed with ATBC in a mixing container then fed into an extruder with a temperature profile across 9 zones ranging from 140 to 170° C. and at a screw speed of 100 rpm. A weight ratio of 15/55/30 (ATBC/TPS/PLA) was employed for this resin composition. The extrudate was collected, pelletized and extruded into film with an average thickness of 0.36 mm and a width of 10-12 inches, using a cast film extruder with a temperature profile of 160 to 170° C. and a screw speed of 50 rpm. The film was chilled and pulled via a set of chiller, guiding and winding rollers to be collected with a spool. The mechanical properties and MFI of the produced resin and the extruded film were then evaluated using a UTM and a melt flow indexer according to ASTM methods, as well as the force recovery test method defined previously. The results are shown in Table 1.

Example 4: A kneader was pre-heated to 230° C. before the addition of PBAT and PLA. The polymers were allowed to melt before TPS was added. The temperature of the kneader was reduced to 185° C. and allowed to mix further for 10 minutes under a mixing speed of 35 rpm until a uniform melt was formed. The resulting material was extracted from the kneader, cooled to room temperature and crushed using a mechanical crusher. The crushed material was then premixed with ATBC in a mixing container then fed into an extruder with a temperature profile across 9 zones ranging from 140 to 170° C. and at a screw speed of 100 rpm. A weight ratio of 15/35/5/45 (ATBC/TPS/PBAT/PLA) was employed for this resin composition. The extrudate was collected, pelletized and extruded into film with an average thickness of 0.33 mm and a width of 10-12 inches, using a cast film extruder with a temperature profile of 160 to 170° C. and a screw speed of 50 rpm. The film was chilled and pulled via a set of chiller, guiding and winding rollers to be collected with a spool. The mechanical properties and MFI of the resin and the extruded film were then evaluated using a UTM and a melt flow indexer according to ASTM methods, as well as the force recovery test method defined previously. The results are shown in Table 1.

TABLE 1
Mechanical properties of polymer blends
with modified starch and additives

| Properties | Example 1 | Example 2 | Example 3 | Example 4 |
|---|---|---|---|---|
| Thickness - | 0.69 | 0.26 | 0.36 | 0.33 |
| mm | | | | |
| Stress at Yield | 2.88 | 2.78 | 2.93 | 0.25 |
| (MD) - MPa | | | | |
| Stress at Yield | 2.88 | 2.73 | 2.35 | 0.27 |
| (TD) - MPa | | | | |
| Stress at Break | 3.32 | 5.2 | 4.93 | 11.59 |
| (MD) - MPa | | | | |
| Stress at Break | 3.32 | 3.31 | 4.33 | 9.81 |
| (TD) - MPa | | | | |
| Young's | 25.91 | 51.15 | 49.39 | 2.36 |
| Modulus (MD) - | | | | |
| MPa | | | | |
| Young's | 25 | 45 | 52.5 | 2.21 |
| Modulus (TD) - | | | | |
| MPa | | | | |
| Strain at Yield | 25.62 | 21.28 | 21.77 | 3 |
| (MD) - % | | | | |
| Strain at Yield | 25 | 18.9 | 12.36 | 3 |
| (TD) - % | | | | |
| Strain at Break | 385 | 396 | 221 | 325 |
| (MD) - % | | | | |
| Strain at Break | 385 | 200 | 151 | 302 |
| (TD) - % | | | | |
| Force recovery | 8.42* | 9.94* | 8.21* | 6.1** |
| (MD) - % | | | | |
| Force recovery | 6.66* | 8.48* | 7.78* | 6.06** |
| (TD) - % | | | | |
| MFI @ 170° C., | NA | 26 | 46 | 80 |
| 2.16 kg - | | | | |
| gr/10 min | | | | |

*Force recovery after 30% initial strain and at 9% holding strain,
**Force recovery after 40% initial strain and at 12% holding strain (The strain rate for the force recovery test was 500 mm/min and the holding time was 12 seconds for all the examples.)

In certain embodiments, the compositions include one or more polymers. In these embodiments, one or more of these polymers are biodegradable polyesters including, but not limited to, polylactic acid, polycaprolactone, polybutylene succinate, polybutylene succinate adipate, polybutylene succinate terephthalate, polybutylene adipate terephthalate, or polyhydroxyalkanoates.

In certain embodiments, the compositions include starch or modified starch.

In certain embodiments, the starch or modified starch is inclusive of but not limited to thermoplastic starch.

In certain embodiments, the biomass includes, but is not limited to, distillers' grains, vinasse, vinegar residues, wood fiber, starch, agricultural cellulosic matter from including but not limited to straw, stalk, shive, hurd, bast, leaf, seed, fruit, and perennial grass, all in a non-continuous non-woven form including chopped pieces, particulates, dust or flour.

In certain embodiments, the inorganic filler includes, but is not limited to, wollastonite, mica, clay, calcium carbonate, glass fiber, talc, aluminum silicate, zirconium oxide, and gypsum.

In certain embodiments, the plasticizer includes, but is not limited to, plant-based oils which could either be virgin or modified (epoxidized, carboxylated, hydroxylated and amidated) as is (from vegetable, nuts, grains, seeds, etc.): e.g. linseed oil, soybean oil, corn oil, glycerol, etc., plant-based oils functionalized: e.g. epoxidized soybean oil, epoxidized linseed oil, fatty acid methyl esters, family of citrate plasticizers such as acetyl tributyl citrate (ATBC), triethyl citrate (TEC), acetyl triethyl citrate (ATEC), tributyl citrate (TBC) and isosorbide-type plasticizers, natural waxes, glycol, sugar alcohols such as xylitol, sorbitol, lactitol, mannitol, erythritol, maltitol, and fatty acid methyl esters (FAME).

In certain embodiments, the coupling agent or compatibilizer includes, but is not limited to, titanate, aluminate, y-aminopropyltriethoxysilane, Y-(2,3) epoxy (propoxy) propyltrimethoxysilane, peroxides, y-methacryloxypropyltrimethoxysilane, lactic acid, formic acid, stearic acid, tannic acid, malic acid, citric acid, aspartic acid, ascorbic acid, acetic acid, tartaric acid.

In other embodiments, the invention includes methods for preparing the biodegradable composition comprising the following steps; plasticizing a starch with the plasticizer(s); mixing uniformly and thoroughly with other raw materials of the biodegradable composition at higher than ambient temperatures to prepare the biodegradable composition.

In other embodiments, the invention includes methods for preparing the biodegradable composition comprising the following steps; mixing uniformly and thoroughly all raw materials of the biodegradable composition at higher than ambient temperatures to prepare the biodegradable composition.

In other embodiments, the invention includes methods for preparing the biodegradable composition comprising the following steps; plasticizing a starch with the plasticizer(s); mixing uniformly and thoroughly with other polymers at higher than ambient temperatures and then mixing uniformly and thoroughly with other raw materials of the biodegradable composition at higher than ambient temperatures to prepare the biodegradable composition.

In other embodiments, the invention includes methods for preparing the biodegradable composition comprising the following steps; mixing uniformly and thoroughly, the polymers at higher than ambient temperatures and then mixing uniformly and thoroughly with other raw materials of the biodegradable composition at higher than ambient temperatures to prepare the biodegradable composition.

In other embodiments, the invention includes methods for preparing the biodegradable composition comprising the following steps; mixing uniformly and thoroughly, specific groups or singular raw materials in certain order at higher than ambient temperatures to prepare the biodegradable composition.

In certain embodiments, the method further comprises forming any articles in any shape and rigidity using conventional polymer processing techniques such as thermoforming, hot press, vacuum forming, cast extrusion, film blowing, or compression molding.

While the present invention has been described with reference to a number of preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A biodegradable resin composition comprising:
a. about 10 to about 99.99% (w/w) of one or more biodegradable thermoplastic polymers;
b. about 0.01 to about 80% (w/w) of one or more biodegradable modified starch;
c. about 0 to about 40% (w/w) of one or more plasticizers;
d. about 0 to about 20% (w/w) of one or more of inorganic fillers;
e. about 0 to about 20% (w/w) of one or more of biomass fillers;
f. about 0 to about 10% (w/w) of one or more of additives such as coupling agents, compatibilizing agents, processing aids, chain extenders, initiators, peroxides, impact modifiers and pigments,
wherein, the composition exhibits force recovery property shortly after being stretched to a certain strain and then returned to a lower strain and held for a period of time.

2. The biodegradable resin composition of claim 1, wherein the resin composition exhibits at least about 5% force recovery within about 60 seconds, while being held at a holding strain of at least 5% after returning from an initial strain of at least about 10% that falls beyond the elastic region on the tensile stress-strain curve of the resin composition.

3. The biodegradable resin composition of claim 1, where the biodegradable thermoplastic polymer is one or more of biodegradable thermoplastic polyesters selected from the group consisting of polylactic acid, polycaprolactone, polybutylene succinate, polybutylene succinate adipate, polybutylene succinate terephthalate, polybutylene adipate-co-terephthalate, polyhydroxyalkanoates and combinations thereof.

4. The biodegradable resin composition of claim 1, wherein the biodegradable modified starch is selected from the group consisting of oxidized starch, esterified starch, plasticized starch, thermoplastic starch, hydrophilicized starch, hydrophobicized starch and enzyme-treated starch, or combinations thereof.

5. The biodegradable resin composition of claim 1, where the plasticizer is one or more plant-based oils obtained from vegetables, nuts, grains, seeds, and combinations thereof, wherein the oil is selected from the group consisting of corn oil, soybean oil, glycerol, epoxidized soybean oil, epoxidized linseed oil, fatty acid methyl esters, citrate plasticizers, acetyl tributyl citrate (ATBC), triethyl citrate (TEC), acetyl triethyl citrate (ATEC), tributyl citrate (TBC), isosorbide-type plasticizers, natural waxes, glycol, sugar alcohols, xylitol, sorbitol, lactitol, mannitol, erythritol, maltitol, isosorbide diester, fatty acid methyl esters (FAME), and combinations thereof.

6. The biodegradable resin composition of claim 1, where the inorganic filler is selected from the group consisting of wollastonite, mica, clay, calcium carbonate, glass fiber, talc, aluminum silicate, zirconium oxide, sepiolite, gypsum or combinations thereof.

7. The biodegradable resin composition of claim 1, where the biomass is selected from the group consisting of distillers' grains, vinasse, vinegar residues, wood fiber, virgin starch, agricultural cellulosic matter, straw, stalk, shive, hurd, bast, leaf, seed, fruit, and perennial grass, all in a non-continuous non-woven form, which may consist of chopped pieces, particulates, dust, or flour or a combination thereof.

8. The biodegradable resin composition of claim 1, wherein the composition exhibits 90% disintegration completion within about 180 to about 365 days in soil at ambient temperature.

9. The biodegradable resin composition of claim 1, wherein the composition exhibits more than 90% disintegration in less than about 12 weeks, and wherein the composition exhibits more than 90% biodegradation in less than 180 days under thermophilic temperature conditions.

10. A method of producing the biodegradable resin composition of claim 1, in which ingredients are mixed and melt-compounded together in a polymer processing equipment or apparatus selected from the group consisting of a batch mixer, a twin screw extruder or a single screw extruder, at elevated temperatures for a time period of several seconds to several minutes.

11. The biodegradable resin composition of claim 1, where the bio-based carbon content of the composition is up to 100%.

12. The biodegradable resin composition of claim 1, for use in articles of any thickness and rigidity made using polymer processing techniques selected from blown and cast film extrusion, compression molding, and injection molding techniques.
